(19) United States
(12) Patent Application Publication
(10) Pub. No.: US 2008/0055108 A1
(43) Pub. Date: Mar. 6, 2008

(54) APPARATUS AND METHOD FOR CONTROLLING LEGACY HOME APPLIANCES

(76) Inventors: Jin-Soo Han, Daejon (KR); Wan-Ki Park, Daejon (KR); Myung-In Ji, Gyeonggi-do (KR); In-Tark Han, Daejon (KR)

Correspondence Address: LADAS & PARRY LLP, 224 SOUTH MICHIGAN AVENUE, SUITE 1600, CHICAGO, IL, 60604, US

(21) Appl. No.: 11/828,493

(22) Filed: Jul. 26, 2007

(30) Foreign Application Priority Data
Aug. 30, 2006 (KR) 10-2006-0083139

(51) Int. Cl. G05B 19/02

(52) U.S. Cl. 340/825.22

(57) ABSTRACT

Provided is an apparatus and method for controlling legacy home appliances based on Zigbee wireless communication. The apparatus includes a home appliances control signal receiving unit for receiving a home appliances control signal from a user; a signal analyzing unit for analyzing the home appliances control signal and identifying a corresponding home appliance; a Zigbee coordinator for transforming the home appliances control signal into a Zigbee signal and transmitting the Zigbee signal to the identified home appliance; a Zigbee signal receiving unit for receiving the Zigbee signal from the Zigbee coordinator; an identification (ID) analyzing unit for analyzing the ID of the transmitted Zigbee signal; a signal transform unit for transforming the Zigbee signal into an infrared rays remote control signal; and an infrared rays signal transmitting unit for transmitting the infrared rays remote control signal to the infrared rays receiving unit.

### FIELD OF THE INVENTION

The present invention relates to an apparatus and method for controlling legacy home appliances based on Zigbee wireless communication; and, more particularly, to an apparatus and method for controlling legacy home appliances using a Zigbee sensor even though there is an obstacle between legacy home appliances in a remote place from a user by transmitting a Zigbee signal for controlling the home appliances to the Zigbee sensors attached to the home appliances through Zigbee wireless communication, transforming the Zigbee signal for controlling home appliances, which the Zigbee sensor receives, into infrared rays remote control signals, and controlling corresponding home appliances in a Zigbee coordinator.

### DESCRIPTION OF RELATED ART

A general method of a technology for controlling conventional legacy home appliances is that a user presses a button of menu/selection installed to home appliances in front of the home appliances or remotely controls the button of menu/selection of home appliances such as a TV, an air conditioner, a videocassette recorder (VCR), and a stereo by an infrared rays remote control. The technology for controlling the home appliances by the infrared rays remote control can remotely control a function of the home appliances by the infrared rays remote control in comparison with a case that user directly controls home appliances in front of the home appliances, thereby providing convenience to people.

The conventional technologies for controlling the home appliances include a home appliances control technology using an infrared rays remote control, a home appliances control technology using a remote control repeater, and a legacy home appliances control technology using an infrared rays (IR)/Radio Frequency (RF) unification remote control. Each conventional technology and problems of the conventional technologies will be described hereinafter.

FIG. 1 shows a conventional apparatus for controlling legacy home appliances using the infrared rays remote control.

The legacy home appliances control technology using the conventional infrared rays remote control can control diverse legacy home appliances using an infrared rays remote control 100 within the field of vision in spite of a distance that the user cannot control a legacy home appliances 110.

The infrared rays remote control 100 includes an infrared rays transmitting unit 101. The infrared rays transmitting unit 101 transmits a home appliances control signal based on infrared rays to an infrared rays receiving unit 111 installed in the legacy home appliances. The infrared rays receiving unit 111 receives the home appliances control signal transmitted from a long distance and controls the home appliances according to the transmitted home appliances control signal.

However, the infrared rays remote control cannot be used to control the home appliances when the vision is not clear, i.e., when there is an obstacle between a remote control and home appliances. Accordingly, there is a problem that the user should move to a location where there is no obstacle between the infrared rays remote control and the home appliances according to arrangement of the home appliances. To overcome the problem of the clear visibility, a technology for controlling the home appliances when the vision is not clear by using a remote control repeater is suggested.

The home appliances control technology using the conventional remote control repeater is a technology that a user can control a function of home appliances through a network in a remote region by simultaneously arranging a plurality of home appliances in a location where a vision is clear. The home appliances control technology can control the home appliances by using the infrared rays remote control at a remote region, just like at home.

However, the conventional technology can normally operate only when the vision between one remote control repeater and a plurality of home appliances is clear. There is also a problem that a location of the remote control repeater should be adjusted when home appliances/furniture of home are temporally rearranged. Actually, it is difficult to maintain a clear vision between all home appliances and one remote control repeater.

FIG. 2 is a block diagram showing the conventional apparatus for controlling legacy home appliances using the IR/RF unification remote control.

The legacy home appliances control technology using the conventional IR/RF unification remote control is a technology for controlling legacy home appliances 230 based on an IR signal or an RF signal.

The IR/RF unification remote control module 220 transmits the IR signal to a home appliance 1 of legacy home appliances 230, transmits the RF signal to the IR/RF unification remote control module 220 and home appliances 2 and 3 of the legacy home appliances 230 which do not have a clear vision. The legacy home appliances 230 receive the IR signal or the RF signal from the RF/IR unification remote control module 220 and are controlled according to the transmitted IR signal or RF signal.

However, the conventional technology has a problem that the IR/RF unification remote control module 220 should have both of an IR transmitter and an RF transmitter and simultaneously the legacy home appliances 230 should have an IR receiver and an RF receiver corresponding to the IR/RF unification remote control module 220.

### SUMMARY OF THE INVENTION

It is, therefore, an object of the present invention to provide an apparatus and method for controlling legacy home appliances using a Zigbee sensor even though there is an obstacle between legacy home appliances in a remote place from a user by transmitting a Zigbee signal for controlling the home appliances to the Zigbee sensors attached to the home appliances through Zigbee wireless communication, transforming the Zigbee signal for controlling home appliances, which the Zigbee sensor receives, into infrared rays remote control signals, and controlling corresponding home appliances in a Zigbee coordinator.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided a an apparatus for controlling legacy home appliances based on Zigbee wireless communication, including: a home appliances control signal receiving unit for receiving a home appliances control signal from a user; a signal analyzing unit for analyzing the transmitted home appliances control signal and identifying a corresponding home appliance; a Zigbee coordinator for transforming the transmitted home appliances control signal into a Zigbee signal in conformity to a Zigbee standard and transmitting the Zigbee signal to the identified home appliance through Zigbee wireless communication; a Zigbee signal receiving unit for receiving the Zigbee signal from the Zigbee coordinator; an identification (ID) analyzing unit for analyzing the ID of the transmitted Zigbee signal; a signal transform unit for transforming the transmitted Zigbee signal into an infrared rays remote control signal when the analyzed ID is the ID of the legacy home appliances controlling apparatus; and an infrared rays signal transmitting unit for transmitting the transformed infrared rays remote control signal to the infrared rays receiving unit of the home appliance.

In accordance with another aspect of the present invention, there is provided a method for controlling legacy home appliances based on Zigbee wireless communication, including the steps of: a) receiving a home appliances control signal from a user; b) analyzing the transmitted home appliances control signal and identifying a corresponding home appliance; c) transforming the transmitted home appliances control signal into a Zigbee signal in conformity to a Zigbee standard and transmitting the Zigbee signal to the identified home appliance through Zigbee wireless communication; d) receiving the transmitted Zigbee signal; e) analyzing ID of the transmitted Zigbee signal; f) transforming the transmitted Zigbee signal into an infrared rays remote control signal when the analyzed ID is its own ID; and g) transmitting the transformed infrared rays remote control signal to the infrared rays receiving unit of the home appliance.

### BRIEF DESCRIPTION OF THE DRAWINGS

The above and other objects and features of the present invention will become apparent from the following description of the preferred embodiments given in conjunction with the accompanying drawings, in which:

FIG. 1 shows a conventional apparatus for controlling legacy home appliances using the infrared rays remote control;

FIG. 2 is a block diagram showing the conventional apparatus for controlling legacy home appliances using an infrared rays (IR)/Radio Frequency (RF) unification remote control;

FIG. 3 shows an apparatus for controlling legacy home appliances in accordance with an embodiment of the present invention;

FIG. 4 is a block diagram illustrating the apparatus for controlling legacy home appliances of FIG. 3;

FIG. 5 shows a Zigbee sensor attached to a place near an infrared rays receiving unit in the outside of the home appliances in accordance with the embodiment of the present invention;

FIG. 6 shows the legacy home appliances controlling apparatus substituting a Zigbee unification remote controller for a home server of FIG. 3 in accordance with the embodiment of the present invention; and

FIG. 7 is a flowchart describing a method for controlling legacy home appliances based on Zigbee wireless communication in accordance with an embodiment of the present invention.

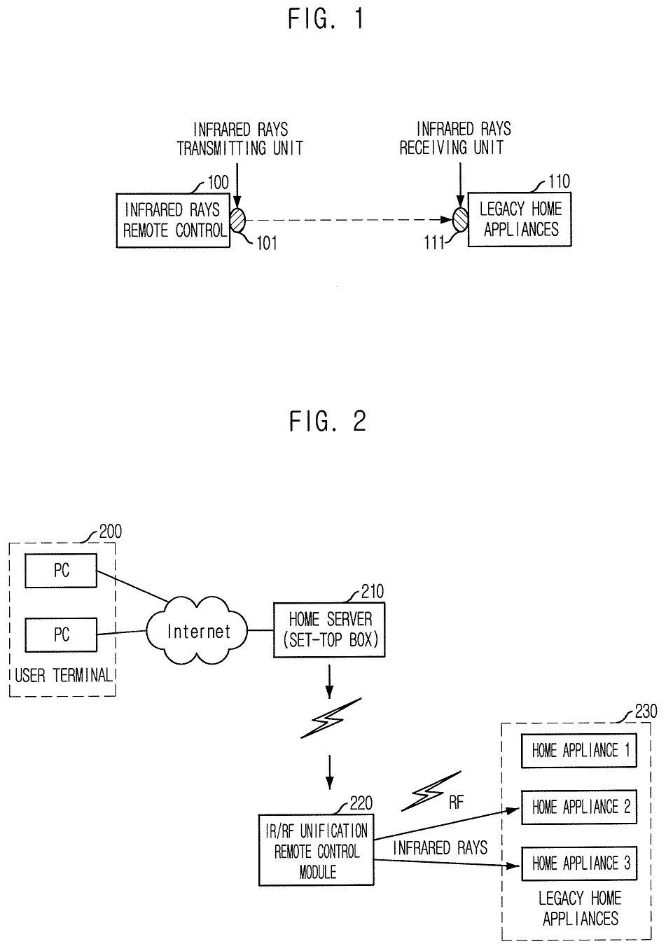

### DETAILED DESCRIPTION OF THE INVENTION

Other objects and advantages of the present invention will become apparent from the following description of the embodiments with reference to the accompanying drawings. Therefore, those skilled in the field of this art of the present invention can embody the technological concept and scope of the invention easily. In addition, if it is considered that detailed description on a related art may obscure the points of the present invention, the detailed description will not be provided herein. The preferred embodiments of the present invention will be described in detail hereinafter with reference to the attached drawings.

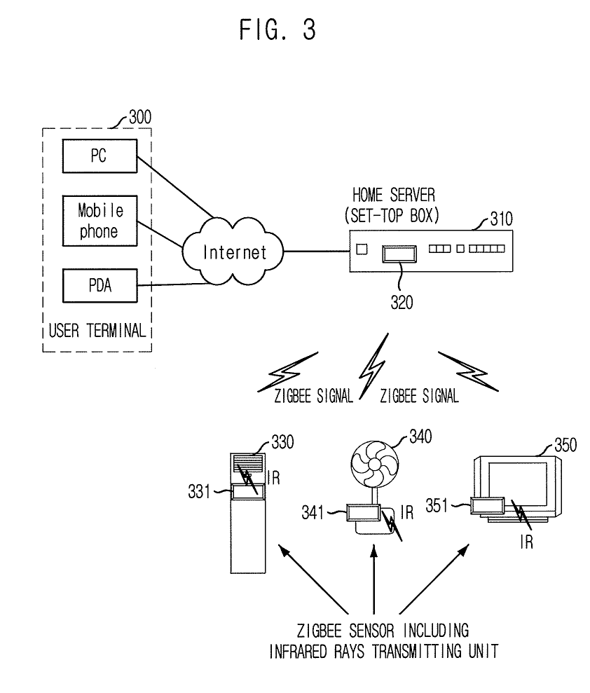

FIG. 3 shows an apparatus for controlling legacy home appliances in accordance with an embodiment of the present invention. The apparatus for controlling legacy home appliances according to the present invention includes a home server 310 including a Zigbee coordinator 320, Zigbee sensors 331, 341 and 351 attached to a place around an infrared rays receiving unit in an outside of home appliances 330, 340 and 350.

The home server 310 receives home appliances control signal from a user of home or outside. The home server 310 receives a home appliances control signal directly from the user. When the user is in the outside, the home server 310 receives a home appliances control signal transmitted from a user terminal 300 connected to an Internet such as a Personal Computer (PC), a mobile phone, a Personal Digital Assistant (PDA).

Subsequently, the home server 310 analyzes the transmitted home appliances control signal and identifies home appliances corresponding to the home appliances control signal. The home server 310 transmits the home appliances control signal to the Zigbee sensors 331, 341 and 351 having corresponding identification (ID) through the Zigbee coordinator 320 installed to the home server 310. The Zigbee coordinator 320 transforms the transmitted home appliances signal in conformity to a Zigbee standard and transmits the home appliances signal through Zigbee wireless communication. The Zigbee coordinator 320 transmits home appliances control signals according to each Zigbee sensor having corresponding ID such that the home server 310 can control different home appliances 330, 340 and 350 according to different Zigbee sensors 331, 341 and 351. The Zigbee sensors 331, 341 and 351 have different ID in conformity to the Zigbee standard.

The Zigbee sensors 331, 341 and 351 are attached to a place near the infrared rays receiving unit in the outside of the corresponding home appliances 330, 340 and 350. When the Zigbee sensors 331, 341 and 351 receive a Zigbee signal corresponding to the ID of the Zigbee sensors from the home server 310, the Zigbee sensors 331, 341 and 351 transform the transmitted Zigbee signal into the infrared rays remote control signals of the home appliances 330, 340 and 350. Subsequently, the Zigbee sensors 331, 341 and 351 transmit the transformed infrared rays remote control signal to corresponding home appliances 330, 340 and 350 such that the home appliances 330, 340 and 350 can be controlled according to the transmitted infrared rays remote control signal.

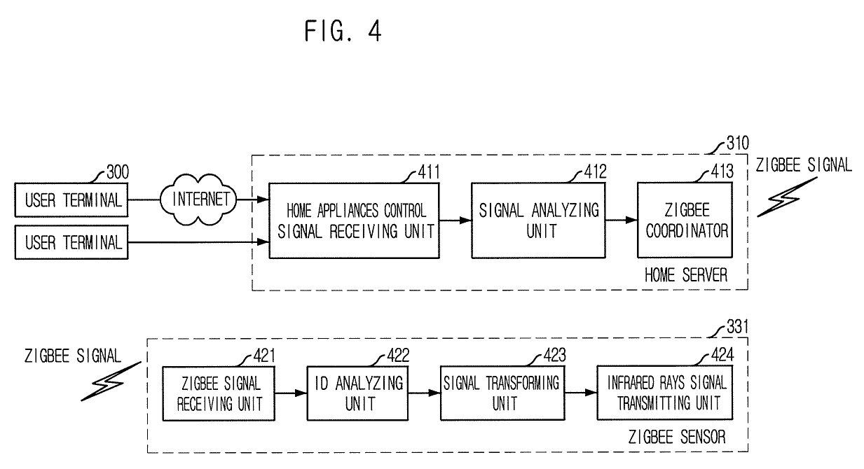

FIG. 4 is a block diagram illustrating the apparatus for controlling legacy home appliances of FIG. 3.

The apparatus for controlling legacy home appliances according to the present invention includes a home appliances control signal receiving unit 411, a signal analyzing unit 412, a Zigbee coordinator 413, a Zigbee signal receiving unit 421, an ID analyzing unit 422, a signal transforming unit 423, and an infrared rays signal transmitting unit 424.

The home appliances control signal receiving unit 411 receives the home appliances control signal from the user.

The signal analyzing unit 412 analyzes the home appliances control signal from the home appliances control signal receiving unit 411 and identifies a corresponding home appliance.

The Zigbee coordinator 413 transforms the home appliances control signal from the signal analyzing unit 412 into a Zigbee signal in conformity to the Zigbee standard and transmits the Zigbee signal to the home appliance identified in the signal analyzing unit 412 through Zigbee wireless communication.

The Zigbee receiving unit 421 receives the Zigbee signal from the Zigbee coordinator 413 through Zigbee wireless communication.

The ID analyzing unit 422 analyzes the ID of the Zigbee signal transmitted from the Zigbee receiving unit 421.

When the ID analyzed in the ID analyzing unit 422 corresponds to own ID, the signal transforming unit 423 transforms the transmitted Zigbee signal into an infrared rays remote control signal. When the ID analyzed in the ID analyzing unit 422 does not correspond to own ID, the signal transforming unit 423 discards the transmitted Zigbee signal.

The infrared rays signal transmitting unit 424 transmits the infrared rays remote control signal from the signal transforming unit 423 to the infrared rays receiving unit of the corresponding home appliance.

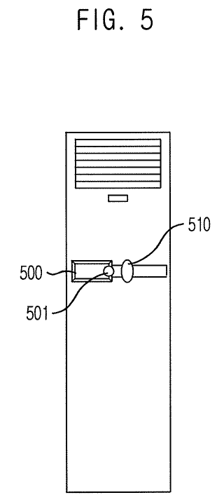

FIG. 5 shows the Zigbee sensor attached to a place near the infrared rays receiving unit in the outside of the home appliances in accordance with the embodiment of the present invention.

A Zigbee sensor 500 attached to a place near an infrared rays receiving unit 510 of the legacy home appliances and includes an infrared rays signal transmitting unit 501. The Zigbee sensor 500 transforms the Zigbee signal into an infrared rays remote control signal and transmits the infrared rays remote control signal.

The Zigbee sensor 500 is arranged in a place where a view of the infrared rays receiving unit 510 is clear in order to control the home appliances by the conventional infrared rays remote control. That is, an angle of the infrared rays signal transmitting unit 501 should be diagonal to the infrared rays receiving unit 510 of the home appliances such that the infrared rays receiving unit 510 can easily receive the transformed infrared rays remote control signal based on the infrared rays signal transmitting unit 501 of the Zigbee sensor 500.

Also, the Zigbee sensor 500 is matched to each of the home appliances. The matching process between each home appliance and the Zigbee sensor 500 is performed based on different IDs of the Zigbee sensor 500 in conformity to the above-mentioned Zigbee standard. That is, when the different IDs of the Zigbee sensor 500 is matched with each of the home appliances, the ID of the Zigbee signal transmitted from the home server is analyzed and the home appliance corresponding to the Zigbee signal is identified.

The Zigbee sensor 500 receives the Zigbee signal from the Zigbee coordinator 413 of the home server, checks the ID of the transmitted Zigbee signal, and transmits only the Zigbee signal corresponding to its own ID to the infrared rays signal transmitting unit 501. Subsequently, the infrared rays signal transmitting unit 511 transforms the transmitted Zigbee signal into the infrared rays remote control signal and transmits the Zigbee signal to the infrared rays receiving unit 510 attached to the side. That is, one of the home servers including one Zigbee coordinator controls a plurality of legacy home appliances based on the Zigbee sensor 500 attached to the outside of each home appliance.

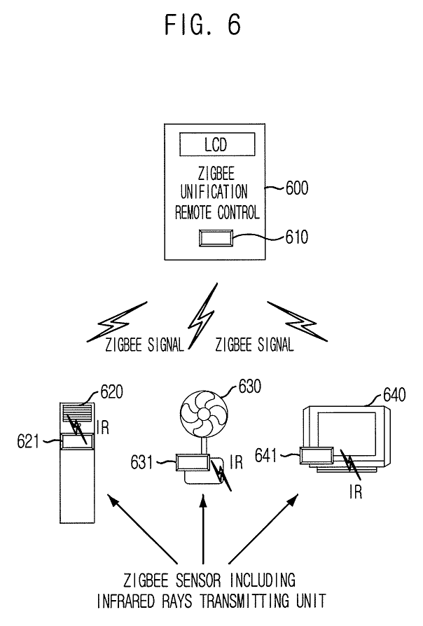

FIG. 6 shows the apparatus for controlling legacy home appliances substituting the Zigbee unification remote control for the home server of FIG. 3 in accordance with the embodiment of the present invention.

The apparatus for controlling legacy home appliances in accordance with another embodiment of the present invention includes a Zigbee unification remote control 600, a Zigbee coordinator 610, and Zigbee sensors 621, 631 and 641.

The Zigbee unification remote control 600 controls home appliances by a Zigbee unification remote control terminal instead of the home server. The Zigbee unification remote control 600 includes an input means of the user and user interface for checking the home appliance selected by the user. Also, the Zigbee unification remote control 600 controls diverse home appliances as one apparatus by transmitting a Zigbee signal to home appliances 620, 630 and 640, just as the home server described above.

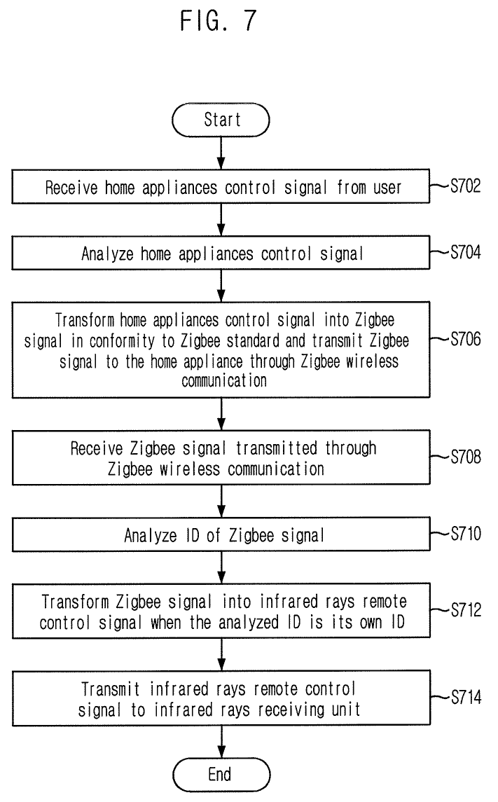

FIG. 7 is a flowchart describing a method for controlling legacy home appliances based on Zigbee wireless communication in accordance with an embodiment of the present invention.

The home server receives a home appliances control signal from the user at step S702. When the user is in the outside, the home server receives a home appliances control signal through an Internet from the user terminal. When the user is at home, the home server receives the home appliances control signal through a user interface of the Zigbee unification remote control directly from the user.

The home server analyzes the transmitted home appliances control signal and identifies a corresponding home appliance at step S704. The home server transforms the transmitted home appliances control signal into a Zigbee signal in conformity to the Zigbee standard and transmits the Zigbee signal to the identified home appliance through Zigbee wireless communication at step S706.

The Zigbee sensor receives the Zigbee signal transmitted through Zigbee wireless communication at step S708 and analyzes ID of the transmitted Zigbee signal at step S710.

When the analyzed ID is its own ID, the Zigbee sensor transforms the transmitted Zigbee signal into an infrared rays remote control signal. Otherwise, the Zigbee sensor discards the transmitted Zigbee signal at step S712. Subsequently, the Zigbee sensor transmits the transformed infrared rays remote control signal to the infrared rays receiving unit of the home appliances at step S714.

The present invention attaches the Zigbee sensor having an infrared rays transmitting function to a place near the infrared rays receiving unit of each legacy home appliance and receives the Zigbee signal for controlling home appliances from the Zigbee coordinator. Accordingly, the user can control the legacy home appliances with no regard to acquiring a view between the user and the legacy home appliances.

Also, the present invention can control the legacy home appliances with no regard to any change of arrangement of home appliances/furniture at home by attaching the Zigbee sensor to a place near the infrared rays receiving unit of the home appliances.

It is also possible to use the present invention for a long time since the Zigbee sensor consumes a little amount of power.

As described above, the technology of the present invention can be realized as a program and stored in a computer-readable recording medium, such as CD-ROM, RAM, ROM, floppy disk, hard disk and magneto-optical disk. Since the process can be easily implemented by those skilled in the art of the present invention, further description will not be provided herein.

The present application contains subject matter related to Korean patent application No. 2006-0083139, filed with the Korean Intellectual Property Office on Aug. 30, 2006, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An apparatus for controlling legacy home appliances based on Zigbee wireless communication, comprising:
a home appliances control signal receiving means for receiving a home appliances control signal from a user;
a signal analyzing means for analyzing the transmitted home appliances control signal and identifying a corresponding home appliance;
a Zigbee coordinator for transforming the transmitted home appliances control signal into a Zigbee signal in conformity to a Zigbee standard and transmitting the Zigbee signal to the identified home appliance through Zigbee wireless communication;
a Zigbee signal receiving means for receiving the Zigbee signal from the Zigbee coordinator;
an identification (ID) analyzing means for analyzing the ID of the transmitted Zigbee signal;
a signal transform means for transforming the transmitted Zigbee signal into an infrared rays remote control signal when the analyzed ID is the ID of the legacy home appliances controlling apparatus; and
an infrared rays signal transmitting means for transmitting the transformed infrared rays remote control signal to the infrared rays receiving unit of the home appliance.

2. The apparatus as recited in claim 1, wherein the home appliances control signal receiving means receives a home appliances control signal through any one between an Internet and a network when the user is in a remote region, and the home appliances control signal receiving means receives a home appliances control signal through a user interface of a remote control when the user is at home.

3. The apparatus as recited in claim 2, wherein the home appliances control signal receiving means selects one home appliance among a plurality of home appliances through the user interface and checks the selected home appliance.

4. The apparatus as recited in claim 1, wherein the Zigbee coordinator transmits a Zigbee signal corresponding to each of the identified home appliances and controls a plurality of home appliances.

5. The apparatus as recited in claim 4, wherein the Zigbee signal receiving means is attached to a place near the infrared rays receiving unit in the outside of the identified home appliance and is matched with each home appliance according to an one-to-one matching method.

6. A method for controlling legacy home appliances based on Zigbee wireless communication, comprising the steps of:
a) receiving a home appliances control signal from a user;
b) analyzing the transmitted home appliances control signal and identifying a corresponding home appliance;
c) transforming the transmitted home appliances control signal into a Zigbee signal in conformity to a Zigbee standard and transmitting the Zigbee signal to the identified home appliance through Zigbee wireless communication;
d) receiving the transmitted Zigbee signal;
e) analyzing identification (ID) of the transmitted Zigbee signal;
f) transforming the transmitted Zigbee signal into an infrared rays remote control signal when the analyzed ID is its own ID; and
g) transmitting the transformed infrared rays remote control signal to the infrared rays receiving unit of the home appliance.

7. The method as recited in claim 6, wherein in the step a), the user receives a home appliances control signal through any one between an Internet and a network when the user is in a remote region, and the user receives a home appliances control signal through a user interface of a remote control when the user is at home.

8. The method as recited in claim 6, wherein in the step c), a plurality of home appliances are controlled by transmitting a Zigbee signal corresponding to each of the identified home appliances.
